(19) United States
(12) Patent Application Publication
(10) Pub. No.: US 2014/0268665 A1
(43) Pub. Date: Sep. 18, 2014

(54) SWIRL WATER LAMP VASE

(71) Applicant: CHIN-SHENG YANG, Tainan City (TW)

(72) Inventor: CHIN-SHENG YANG, Tainan City (TW)

(21) Appl. No.: 13/798,180

(22) Filed: Mar. 13, 2013

(51) Int. Cl. F21V 33/00

(52) U.S. Cl. CPC F21V 33/0028
USPC 362/101

(57) ABSTRACT

The present invention is related to a swirl water lamp vase, which comprises a mean seat body, internal of it is provided a magnetic component rotated driven by the power motor, and the open end of the main seat body is provided a water lamp holder which can accommodate space, and the bottom of the water lamp holder is provided a magneto-motive component corresponding to the rotation of the magnetic component and light emitting group, in order to using the adsorption of the motor to drive the rotation of the magnetic component, making the liquid of the internal water lamp generate the swirling and glary flowing effects, simultaneously, the accommodating space has the functions of accommodating flowers and plants, by the description as above, it makes the water lamp vase has the double interesting efficacies of the glary visual and fluid visual.

### (a) TECHNICAL FIELD OF THE INVENTION

The present invention generally relates to swirl water lamp vase, and more particularly to a vase design for the environmental space which has double interesting efficacies of glare visual and fluid visual.

### (B) DESCRIPTION OF THE PRIOR ART

Nowadays, industrial and commercial activities are busy, people live in the city, forcing all their mental on the work whole day, while the daily pace are more and more fast, living relatively becomes lack of vitality. Therefore, many people place plants such as flowers in the surroundings to green up the space, because the plants can not only beatify the environment, but also bring the fresh air, it creates the most comfortable visual focus, softens the tense body and mind of the modern people.

Therefore, except for the types, placement, etc of the flowers, the requirements of the vase relatively increase along with people's living standards, if it is able to increase other interesting of the vase, and coordinate the flowers to form a pleasant installation art, it is surely more popular for the general public.

Accordingly, the present invention designs a swirl water lamp vase by experience of studying for furnishings and decorations, combining the functions of the day's gorgeous and the night's shining visual, after continuous try and improvement, the present invention has invented.

### SUMMARY OF THE INVENTION

Accordingly, the present invention is related to a swirl water lamp vase, it mainly comprises:

a main seat body, a hollow seat body with an open end;

a power motor, corresponded and provided in the main seat body, and the shaft end of the power motor is provided a magnetic component;

a light emitting group, corresponded and provided to the inner peripheral edge of the open end of the main seat body;

a water lamp vase holder, a translucent vase shape housing, its center has an opening upward accommodating space, inside of the housing is coated the fluid liquid, the water lamp vase holder is corresponded and combined on the open end of the main seat body and the top of the light emitting group, and the bottom of the interior of the housing has a magneto-motive component corresponded to the magnetic component.

Accordingly, using the power motor to drive the rotation of magneto-motive component, making the liquid in the water lamp vase generate the swirling flow, simultaneously, the accommodating space has the functions of accommodate flowers and plants, according to the above, it makes the water lamp vase has both interesting functions of glare visual and fluid visual.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a stereoscopic exploded schematic diagram of the present invention.

FIG. 2 is a stereoscopic diagram of the present invention.

FIG. 3 is a sectional view of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

First of all, referring to the FIG. 1 and FIG. 2, which are the stereoscopic exploded schematic diagram and stereoscopic diagram in the present invention, the swirl water lamp vase 1 mainly comprises a main seat body 2, a power motor 3, a light emitting group 4 and a water lamp holder 5. The power motor 3 and the light emitting group 4 are provided in the main seat body 2, and the water lamp holder 5 is combined on the top of main seat body 2.

A main seat body, a hollow seat body with an open end 21, in this embodiment, the main seat body 2 is slightly cone, but it does not limit the appearance;

A power motor 3, corresponded and provided in the main seat body 2, and the shaft end of the power motor 3 is provided a magnetic component 31;

A light emitting group, which is light emitting diode (LED), corresponded and provided to the inner peripheral edge of the open end 21 of the main seat body 2;

A water lamp vase holder 5, a translucent vase shape housing, its center has an opening upward accommodating space 51, inside of the housing is coated the fluid liquid, and the fluid liquid can be added bright chips and bright powders, the water lamp vase holder 5 is corresponded and combined on the open end 21 of the main seat body 2 and the top of the light emitting group 4, and the bottom of the interior of the housing having a magneto-motive component 52 corresponded to the magnetic component 31.

Coordinating to FIG. 3, which is a sectional view of the present invention, while the water lamp vase 1 is used, it connects the power motor 3 in the main seat body 2 with the power at first, making has the power to drive the power motor 3 rotation and the magnetic component 31 rotates, simultaneously, the power also supplies the light emitting group 4 to generate the lights, the power is the design of the general practice, and it is not the detail in the field of the present invention, so it won't be described.

As mentioned above, while the magnetic component 31 is rotating, it uses the magnetic principles, making the magneto-motive component 52 corresponding in the water lamp holder 5 generate the rotating operation, and the rotation phenomenon drives the liquid in the water lamp holder 5 flowing swirly, and it coordinates to the light irradiation of the light emitting group 4 becoming more gorgeous, simultaneously, through the effect of the swirly flowing, it can make the bright chips and bright powders added in the liquid float and wave. In this way, it can generate the gorgeous and interesting swirl water lamp vase 1; otherwise, there is provided the flow conducting fin 53 on the top of the magneto-motive component 52 in the water lamp holder 5, it can make the internal liquid flow more significantly, and produce more obviously dazzling swirling flowing phenomena.

By the above description of construction and actuation, the swirl water lamp vase in the present invention has the advantages not only that its accommodating space 51 has the functions of accommodating the flowers and the plants, but also the interesting efficacies of the glaring visual and fluid visual.

As mentioned above, it can be realized that the swirl water lamp vase in the present invention has several advantages as below on using and is better than the conventional structure:
1. The swirl water lamp vase in the present invention can generate the swirling flowing liquid of the internal of the transparent water lamp holder by the power motor magnet component driving the magneto-motive component which is provided in the main seat body, and manifesting gradient dynamic interesting water lamp vase.
2. The swirl water lamp vase in the present invention can be used for night vision with the light efficacy by the light of the light emitting group coordinating to the transparent water lamp holder.
3. As mentioned both above, the main seat body of the swirl water lamp vase in the present invention is provided a magnet component which can generate rotation to drive the transparent water lamp holder to make the internal liquid flow swirly, simultaneously, there is a light emitting group provided on the main seat body, to achieve the double interesting efficacies of glary visual and fluid visual.
   Therefore, as known by the embodiment in the present invention, the present invention really can perfectly show the efficacy of the swirl water lamp vase, and the component design in the present invention is provided the light emitting group and magnetic component, it has the double efficacies and visual experience of the night vision illuminating and visual admiring, it really can be a very improved and progressive structure invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A swirl water lamp vase, comprising:
a main seat body, a hollow seat body with an open end;
a power motor, corresponded and provided in the main seat body, and the shaft end of the power motor being provided a magnetic component;
a light emitting group, corresponded and provided to the inner peripheral edge of the open end of the main seat body;
a water lamp vase holder, a translucent vase shape housing, its center having an opening upward accommodating space, inside of the housing being coated the fluid liquid, said water lamp vase holder being corresponded and combined on the open end of the main seat body and the top of the light emitting group, and the bottom of the interior of the housing having a magneto-motive component corresponded to the magnetic component;
wherein a gorgeous effect can be achieved through using the power motor to drive the rotation of magneto-motive component, making the liquid in the water lamp vase generate the swirling flow, coordinating the irradiation of the light emitting group.

2. The swirl water lamp vase according to claim 1, wherein said light emitting group is a light emitting diode

3. The swirl water lamp vase according to claim 1, wherein said magneto-motive component is provided a flow conducting fin.
